(19) United States
(12) Patent Application Publication
(10) Pub. No.: US 2009/0280468 A1
(43) Pub. Date: Nov. 12, 2009

(54) Systems and methods for providing early warning of student absence

(76) Inventor: David Yaskin, Arlington, VA (US)

Correspondence Address: MCDERMOTT, WILL & EMERY, 11682 EL CAMINO REAL, SUITE 400, SAN DIEGO, CA, 92130-2047, US

(21) Appl. No.: 12/151,581

(22) Filed: May 6, 2008

(51) Int. Cl. G09B 7/00

(52) U.S. Cl. 434/362

(57) ABSTRACT

Systems and methods are provided for electronically providing notification that a student has not been engaged with an educational institution for a predefined period of time. Student interaction data may be captured, wherein the student interaction data has one or more data elements and relates to use of the one or more facilities, services, or facilities and services of the educational institution. The systems and methods may determine an absence of student interaction data for the predefined period of time, and provide providing a notification to a predefined authority based on the determined absence of student interaction. The systems and methods may further notify predefined authority for prolonged absence of a visiting student, or absence of student interaction data related to dining facilities of an educational institution. The systems and methods may monitor student performance and correlate the absence of student interaction data with academic performance.

### FIELD

The present disclosure generally relates to computer software and hardware systems, and, in particular, relates to systems and methods for providing early warning of student absence.

### BACKGROUND

Safety and security of members of an educational institution (e.g., student, faculty, staff, etc.) is a significant concern for the administration of the educational institution. Moreover, with an increasing number of part-time students, non-traditional students, and foreign students seeking educational opportunities, educational institutions desire to determine whether these students are regularly attending classes, and using educational institution facilities and resources such as dining services and dormitories.

Additionally, government agencies may be interested in determining whether student visas granted to individuals are being used to further education of a student, and not merely provide an individual with a lengthy period of access to the country.

In an effort to promote student responsibility and learning, an educational institution may have general rules concerning absences from class. Faculty may have additional policies regarding attendance, and may take absences into account in determining final grades. Also, accreditation governing organizations may require students to participate in a particular number or percentage of classes. Various organizations, such as a student senate, may have attendance policies in order to maintain a quorum to act on resolutions made by the senate.

It is desirable for an educational institution to determine the absence of student interaction with the facilities, services, or utilization of resources of an educational institution. It is further desirable to provide notification to an authority based on the absence of student interaction with an education institution. Accordingly, there exists a need for systems and methods to electronically provide notification to an authority when there is absence of captured student interaction data with the educational institution.

### SUMMARY

Early warning systems and methods may be used to provide notification to designated individuals that a student has not been engaged with educational and service offerings of an educational institution for a predefined period of time. For example, the student may not have utilized his or her student identification card or other device (e.g., electronic device containing student data, universal account, etc.) to access buildings, enter a dormitory facility, access campus information technology computer systems, attend class, or attend any activity, or use the card or device's financial or meal account balance. The systems and methods may compare any absence of student interaction data with the educational institution's academic calendar (e.g., to determine if the absence of data occurred on a weekend or a holiday recognized by the educational institution). The exemplary systems and methods may be used to monitor visiting students (e.g., from other educational institutions, from other countries or geographic regions, etc.), enable the monitoring of student academic performance (e.g., failure to attend classes on a regular basis), and provide an early warning that a student is missing so that appropriate measures may be taken.

Systems and methods are provided for electronically providing notification that a student has not been engaged with an educational institution for a predefined period of time. The systems and methods relate to capturing student interaction data, wherein the student interaction data has one or more data elements and relates to use of the one or more facilities, services, or facilities and services of the educational institution. The systems and methods further comprise determining an absence of student interaction data for the predefined period of time, providing a notification to a predefined authority based on the determined absence of student interaction.

The systems and methods may further comprise capturing student interaction data by reading a swiped card configured with student data, reading a card configured with personal data with a proximity reader, retrieving student data stored on an electronic device via a wired or wireless communication interchange, recording a computer login event using student identifier data, or digitally capturing student identification information from an electronically submitted communication, or any combination thereof.

The student interaction data captured by the systems and methods may indicate athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, on-campus retail facilities utilization, off-campus retail facilities utilization, on-line retail facilities utilization, entertainment facilities utilization, library facilities utilization, or student center facilities utilization, on-campus resource utilization, off-campus resource utilization, or any combination thereof.

The systems and methods may further comprise correlating student wellness with the captured student interaction data indicating the dining facilities utilization data. The notification provided to a predefined authority may be based on the absence of dining facilities student interaction data.

The systems and methods may further comprise comparing an academic calendar of the educational institution with the determined absence of student interaction data.

In determining the absence of student interaction data, the systems and methods may further comprise determining if the student is a visiting student.

The systems and methods may further comprise monitoring student academic performance, and correlating the absence of student interaction data with student academic performance. The determining the absence of student interaction data for the predefined period of time may further comprise applying factor analysis.

The disclosure also encompasses program products for providing notification that a student has not been engaged with an educational institution based on the absence of captured student interaction data of the type outlined above. In such a product, the programming is embodied in or carried on a machine-readable medium.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 illustrates an exemplary block-level diagram of an educational institutional environment in which a student absence early warning system is implemented according to an exemplary embodiment;

FIG. 2 is a flow diagram for providing notification to an authority based on determined absence of a student according to an exemplary embodiment;

FIG. 3 illustrates a display that enables a user to students with an absence of interaction data according to an exemplary embodiment;

FIG. 4 depicts a display indicating absence of student interactions for a particular student for a date range wherein the display provides notification options according to an exemplary embodiment;

FIG. 5 illustrates a graphical display indicating absence of student interactions with an educational institution's dining services and notification options according to an exemplary embodiment; and

FIG. 6 depicts a display indicating class, test, and assignment absences for a particular student and notification options for academic alert according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

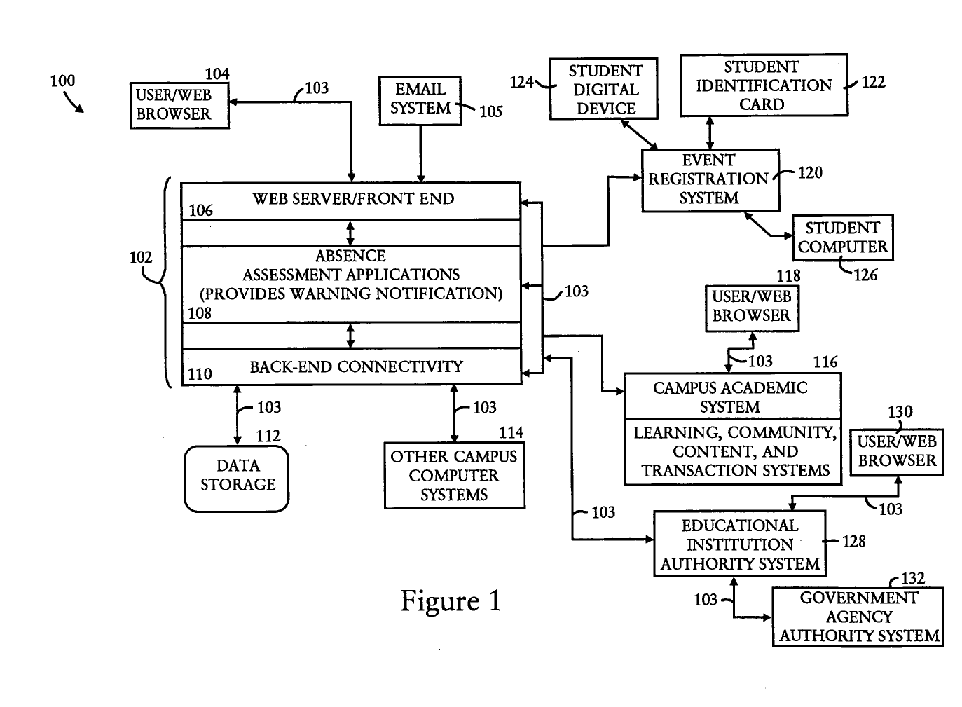

FIG. 1 depicts a functional block diagram of an exemplary early warning student absence system 100. As described in more detail herein, data correlation system 100 may provide a framework for providing notification that a student has not been engaged with an educational institution for a predefined period of time. Computing system 102 may be one or more computers (e.g., one or more servers, personal computers, minicomputers, mainframe computers, or any other suitable computing devices, or any combination thereof) that may be configured with front-end 106, absence assessment applications 108, and back-end connectivity 110.

User computer 104 may be configured to communicate with computer system 102 via a web browser or similar interface to communicate with an appropriately configured front-end 106 of system 102. Communication between user computer 104 and front end 106 of computer system 102 may be via communications link 103, which may be a wireless or wired communications link such as a local area network, wide area network, the Internet, or any other suitable communications network. Front-end 106 may be, for example, a web server or other computing device hosting one or more absence assessment applications 108 that user computer 104 may access. Applications 108 may be one or more software components or programs that execute on a programmable computer platform of computer system 102 to provide functionality related to correlating student interaction data with early warning of student absence. Such applications 108 may include components for capturing student interaction data, and determining whether to provide early warning notifications to a designated administrator or other person when an absence of interaction data is determined. Applications 108 may determine a student's class absences, missed homework submission, missed tests and quizzes, or other missed academic events and provide an academic warning to an academic advisor or other administrator. Applications 108 may also correlate a student's meal plan and use of dining facilities with eating disorder problems.

Computing system 102 may also access data storage facilities 112 and other computer systems 114 via communications link 103. For example, data storage facilities 112 may be one or more digital data storage devices configured with one or more databases having student data (e.g., student identification number, student name, student gender, student race, courses completed, courses enrolled in, degree program, certificate program, etc.) and may also contain data received from a registration event with a student identification card, device configured with student information, and/or from registering an event by which a student entered identification data (e.g., a login event to a educational institution computer network application using student identification information). Data storage facilities 112 may store and arrange data in a convenient and appropriate manner for manipulation and retrieval. Other computer systems 114 may be a variety of third-party systems that contain data or resources that are useful for the data correlation system 100. In the exemplary higher education environment, systems 114 may include a student information system (SIS) that maintains student demographic information. Systems 114 may also include an electronically maintained class or course schedule for the institution that includes information about the courses such as section numbers, professors, class size, department, college, the students enrolled, etc. Other campus-related systems such as financial aid and the bursar's office may be included in systems 114 of FIG. 1.

Back-end connectivity 110 of computer system 102 may be appropriately configured software and hardware that interface between applications 108 and resources including, but not limited to, data storage 112 and other computer systems 114 via communications link 103.

Another resource to which the back end 110 may provide connectivity (e.g., via communications link 103) is a campus (or institutional) academic system 116. Campus academic system 116, in an academic environment, provides a platform that allows students and teachers to interact in a virtual environment based on the courses for which the student is enrolled. This system may be logically separated into different components such as a learning system, a content system, a community system, or a transaction system, or any other suitable system, or any combination thereof. For example, a student, administrator, faculty or staff member may operate user computer 118 to access academic system 116 via a web browser or similar interface.

Of particular usefulness to system 100, academic system 116 may provide a virtual space that user computer 118 may access to receive information and to provide information. One exemplary arrangement provides user computer 118 with a webpage where general information may be located and that has links to access course-specific pages where course-specific information is located. Electronic messaging, electronic drop boxes, and executable modules may be provided within the user's virtual space on the academic system 116. Thus, with respect to computer system 102, one of applications 108 may be used to generate information that is to be deployed to one or more users of academic system 116. Via back-end 110, the information may be sent to academic system 116 where it is made available to user computer 118 just as any other information may be made available. Similarly, from within the academic system 116, the user may enter and submit data that is routed through the back end 110 to one of the applications 108. Academic system 116 and computer system 102 may be more closely integrated so that the connectivity between the applications 108 and the system 116 is achieved without a network connection or back end software 110.

System 102 may be communicatively coupled to one or more registration systems 120, which may be a card reader, proximity reader, or other suitable system configured to capture information from student identification card 122, student digital device 124 (e.g., cellular phone, personal digital assistant, handheld computing device, laptop computer, etc.), or student computer 126. Although only one student identification card 122, student digital device 124, and computer 126 are shown, there may be one or more of each respective device that may communicate with registration system 120. Identification card 122, digital device 124, and/or computer 126 may be configured with student identification information (e.g., student name, student identification number, class schedule, major, dining services plan, dormitory, gender, race, nationality, etc.). For example, student identification card 122 may be swiped, scanned, or registered by proximity by registration system 120 at an event (e.g., student attending class, cultural event, entertainment event, athletic event, etc.) to capture and associate attendance by the student at the particular event. In another example, student identification card 122 may be swiped, scanned, or registered by proximity by registration system 120 at the entrance or exit of a particular facility (e.g., classroom, lecture hall, student union, dormitory, library, dining service facility, athletic facility, etc.). Alternatively, student digital device 124 may communicate student identification information via a wired or wireless communications link with registration system 120 at an event. Also, student computer 126 may communicate with registration system 120 to provide student information at a login event or other information exchange event (e.g., electronic homework assignment submission by a student, wherein registration system captures the student identification information, as well as one or more data elements regarding the course and the assignment submission, etc.). Data captured by registration system 120 may be transmitted to computer system 102 via communications link 103 for processing (e.g., by applications 108, etc.) and/or storage (e.g., stored in data storage 112, etc.).

For example, data may be captured from student identification card 122 or student digital device 124 that is related to presence, utilizations, or transactions. For example, a student may use card 122 or device 124 to enter or exit a classroom, lecture hall, dormitory, library, athletic facility, dining services facility, or other facility of the educational institution. Card 122 or device 124 may also be enabled with banking account, declining balance account, or credit card account information, or other financial transaction enabling information to facilitate the purchase of the items.

Data may be captured from student identification card 122 or student digital device 124 related to presence, utilizations, and transactions by a student. For example, a student may use card 122 or device 124 to purchase a ticket for a concert for the city symphony or a ticket for an exhibit at the city art museum. Card 122 or device 124 may be enabled with banking account, declining balance account, or credit card account information, or other financial transaction enabling information to facilitate the purchase of the tickets. Additionally, attendance of the symphonic concert or art museum exhibit by the student may be registered by registration system 120, which may be present at the city symphonic hall where the concert is being performed or at the art museum in order to receive student identification data and event information data (e.g., concert information, location of symphony hall, time of attendance, etc.) from the swiping or registering of student identification card 122 or device 124.

In another example, a student may use card 122 or device 124 to purchase a bus ticket or bus pass from the city's transportation authority. Again, card 122 or device 124 may also be enabled with banking account, declining balance account, or credit card account information, or other financial transaction enabling information to facilitate the purchase of the bus ticket (e.g., single ride, round-trip, etc.) or bus pass (e.g., 2 ride pass, 4 ride pass, weekly pass, weekend pass, monthly pass, academic year pass, year pass, etc.). Alternatively, a student may purchase a bus pass or ticket with card 122 or device 124, and information related to the pass or ticket may be associated with card 122 or device 124. Upon using the bus with card 122 or device 124 having associated bus pass or ticket information, the bus may be equipped with at least a portion of registration system 120 to register student use of the bus (e.g., identification information of the student, bus route information, time used, etc.) and may deduct from the bus use allowance of the purchased bus ticket or pass (e.g., deduct a day of use from the weekly pass purchased from the student's account, etc.).

In yet another example, a student may use card 122 or device 124 to purchase a pizza from an off-campus merchant, or purchase a Calculus study guide from the on-campus bookstore. During the purchasing transaction, card 122 may be swiped or read by a proximity reader (e.g., event registration system 120), and data may be captured such as the identity of the student, the location of the purchase (e.g., name and location of off-campus vendor), and data related to the items that were purchased (e.g., large pepperoni pizza; title, author, and publisher of the Calculus study guide purchased; cost of the items, etc.). Card 122 or device 124 may also be enabled with banking account, declining balance account, or credit card account information, or other financial transaction enabling information to facilitate the purchase of the items. In another example, student computer 126 may be used in an on-line purchasing transaction with an on-line merchant, wherein the student identification, identification information related to the items purchased, and information related to the on-line vendor may be captured by event registration system 120 (e.g., student computer 126 may transmit the information to event registration system 120 after the transaction).

Event registration system 120 may capture presence and utilization data by capturing data from student identification card 122, digital data device 124, and/or student computer 126 at particular events. For example, card 122 may be scanned (e.g., using event registration system 120) at the entrance of the educational institution's library (e.g., card 122 may be scanned at the entrance and exit of the library to record the times associated with entering and leaving), and may be scanned again when a student checks out a book. Thus, event registration system 120 may capture data related to the identity of the student, as well as the duration of time that the student was in the library, and information related to the book that the student checked out (e.g., author, title, genre, etc.). Similar registration of card 122 or device 124 by event registration system 120 may occur, for example, if the student attends a sporting event (e.g., a football game, etc.) or a cultural event such as a music concert (e.g., concert by string quartet, chamber orchestra, jazz band, etc.).

Computer system 102 may be communicatively coupled via communications link 103 to educational institution authority system 128. Notifications generated by absence assessment applications 108 may be provided to educational institution authority system 128 for review by a user (e.g., an administrator or other designated individual). User computer 130 may be communicatively coupled to educational authority system 128, and may view notification via a web browser or other suitable interface. Notifications may include whether there is an absence of student interaction data captured for a particular student for a predefined period of time (e.g., 1 day, 3 days, 5 days, etc.). Notifications may also be provided from applications 108 when a student, who has a dining services meal plan, has not utilized dining services for a predefined number of meals (e.g., 2 meals, 3 meals, 4 meals, etc.) or in a predefined time period (e.g., 1 day, 2 days, 3 days, etc.). Academic alert notifications may also be provided from applications 108 to educational institution authority system 128. The academic alert notifications may be issued when a student has missed a predefined number of classes (e.g., 3 classes, 4, classes, 5 classes, etc.), has failed to submit a predefined number of assignments (e.g., 2 assignments, 3 assignments, etc.), has missed a predefined number of tests or quizzes (e.g., 1 test or quiz, 2 tests or quizzes, etc.), or has missed any other educational event, or any combination thereof.

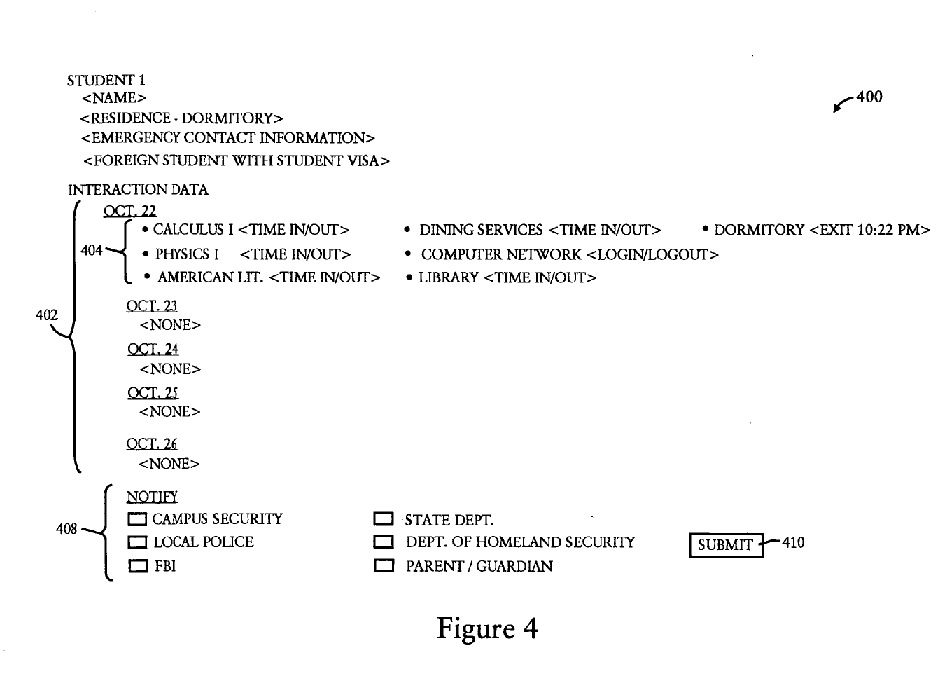

An administrator or other user utilizing computer 130 may view the notifications received by educational institution authority system 128 and may select other individuals, groups or organizations to receive notification. For example, an administrator may select campus security, local police, the Federal Bureau of Investigation (FBI), the United States Department of State (e.g., if the absent student has a student visa issued by the State Department), Department of Homeland Security, the educational institution's counseling center, the educational institution's tutoring services, the educational institution's wellness center, a nutritionist, a resident advisor, an academic advisor, or a parent or guardian of the student, or any combination thereof. Exemplary displays indicating such selections are illustrated in FIGS. 4-6 and are discussed below. If an administrator selects a government agency (e.g., U.S. Department of State, Department of Homeland Security, etc.) to send the notification to, educational institution authority system 128 may direct the notification to government agency authority system 132 via communications link 103.

Although front end 106, applications 108, and back end 110 of the computer system 102 are each depicted as a single block in FIG. 1, one of ordinary skill will appreciate that each may also be implemented using a number of discrete, interconnected components. As for the communication links between the various blocks of FIG. 1, a variety of functionally equivalent arrangements may be utilized. For example, some links may be via the Internet or other wide-area network, while other links may be via a local-area network or even a wireless interface. Also, although only a single computer 104 of computer system 102 is explicitly shown, multiple users and multiple computers or computing devices may be utilized in system 100. The structure of FIG. 1 is logical in nature and does not necessarily reflect the physical structure of such a system. For example, computer system 102 may be distributed across multiple computer platforms as can the data storage 112. Furthermore, components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both computer system 102 and the academic system 116.

Correlating student interaction data with class schedules, dining services plans, academic performance (e.g., grades on assignments, tests, quizzes, labs, etc.), and academic calendars of an educational institution is a complex undertaking that encompasses many different levels of data collection and analysis. System 100 may be used to capture student interaction data from one or more sources from facility entry data, utilization of resources at the educational institution (e.g., use of dining services, etc.), electronic submissions of assignments or other information, and correlate the student interaction data with class schedules, dining services plans, academic performance and academic calendars to determine absence and provide notifications to predetermined authorities.

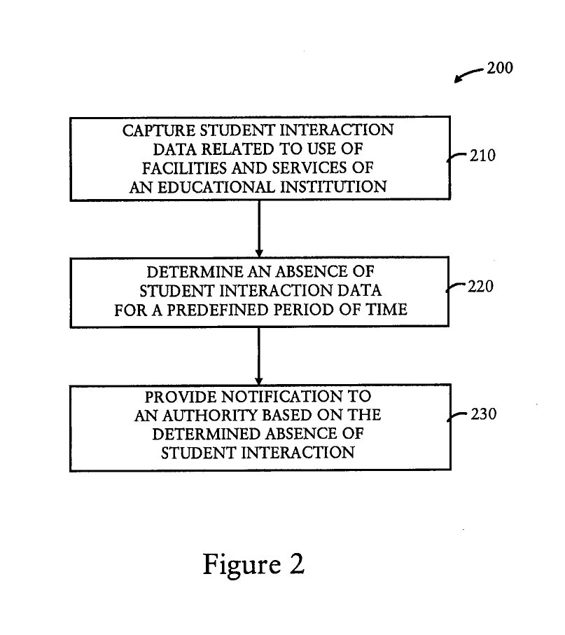

FIG. 2 depicts an exemplary diagram for flow 200 for providing notification that a student has not been engaged with an educational institution for a predefined period of time. Computer system 102 (FIG. 1) configured with applications 108 may, for example, perform flow 200. At block 210, at least some student interaction data may be captured, where the captured data has one or more elements. The captured data elements may relate to the use of one or more facilities, services, or facilities and services of the educational institution.

For example, system 100 may capture data (e.g., using registration system 120) related to student interaction data. The captured student interaction data may relate to, for example, when and where a student has attended class, visited the library, used dining services, entered and exited a dormitory, utilized an athletic facility, utilized entertainment offerings on- or off-site from an educational campus, participated in educational online organizations, attended educational events or lectures outside of class, patronage of on-campus merchants, patronage of off-campus merchants, patronage of on-line merchants, electronic submission of an assignment or other document, or electronic submission of personal identification information, utilization of an on-campus resource, utilization of an off-campus resource (e.g., public transportation and/or other transportation systems, etc.), or any transactional or utilization information, or any combination thereof.

Also, the captured data may also include personal data that may be requested and received by computer system 120 from various sources in system 100 (e.g., from campus academic system 116, data storage 112, and/or campus computer system 114 of FIG. 1). Personal data may include, but is not limited to personal demographic data, student degree program, student certificate program, courses completed, course type (e.g., on-line courses, distance learning courses, on-campus courses, summer courses, continuing education courses, etc.), courses needed for completion of the degree or certificate program, faculty department, staff department, or any other suitable information, or any combination thereof. The personal data may be stored, for example in data storage 112, other campus computer 114, campus academic system 116, or any other suitable digital storage device communicatively coupled to computer system 102.

At block 220, system 100 may determine an absence of student interaction data for the predefined period of time. For example, computer system 102 of system 100 may determine that a student has not attended one or more classes that the student was scheduled to attend (e.g., based on a student schedule stored in data storage 112 or campus academic system 116 of FIG. 1) as there is an absence of data for the student. The absence of data for a particular student may be correlated with an educational institution's academic calendar, or previous notification from a student to the administration regarding a student's intended absence (e.g., for a family emergency, religious observance not recognized as a holiday by the educational institution, funeral service, etc.), or any other suitable information. In another example, computer system 102 may correlate at least some of the captured student interaction data by applying factor analysis, as described in further detail below, to determine if an academic early warning should be sent to an administrator, advisor, or other person because the student has missed a predetermined number of classes, quizzes or tests, or failed to submit a particular number of assignments. In another example, computer system 102 may use factor analysis to determine whether a nutrition warning should be sent to an administrator or other designated person as the captured student data may indicate an absence in the regular use of dining services based on the student's selected dining plan, or the captured student data related to dining may indicate that the student is not eating a healthy diet.

At block 230, computer system 102 of system 100 may provide notification to an authority based at least in part on the determined absence of student interaction data. For example, an administrator may be notified that a student that has an absence of student interaction data for a predetermined period of time (e.g., 1 day, 2 days, 3 days, etc.). The administrator may notify one or more entities (e.g., campus security, local police, parent or guardian of the student, resident advisor, Department of Homeland Security, U.S. Department of State, etc.), or the entities may be directly notified by system 100. In another example, an academic warning may be sent to one or more faculty, an academic advisor, a parent or guardian of a student, a tutor at the educational institution, or other entity may be notified if a student has missed a predetermined number of classes, failed to turn in assignments, missed one or more tests or quizzes, or any other academic events. In yet another example, system 100 may provide a health warning to a designated person or entity upon system 100 determining that a student has missed a predefined number of meals, or is eating unhealthily on a predefined basis.

Factor analysis may be used by the exemplary systems described herein (e.g., system 100 of FIG. 1) as a statistical data reduction technique that may be used to explain variability among observed random variables in terms of fewer unobserved random variables (i.e., factors). The observed variables may be modeled as linear combinations of the factors. An advantage of factor analysis is the reduction of the number of variables by combining two or more variables into a single factor. Accordingly, factor analysis may be used for data reduction. For example, specific factors may be combined into a general, overarching factor such as student absence or academic performance. Another advantage of factor analysis is the identification of groups of inter-related variables to determine how they are related to each other. Thus, factor analysis may also be used as a structure detection technique. For example, selection of particular foods or absence of utilizing dining services by a student may relate to an eating disorder.

Correspondence analysis also may be performed by the exemplary systems as described herein. Correspondence analysis may be used, for example, to analyze two-way and multi-way tables containing one or more measures of correspondence between data (i.e., data in the rows and columns of the table). The results may provide information which is similar in nature to those produced by factor analysis techniques. The structure of categorical variables included in the table may be identified and summarized for presentation to a user (e.g., administrator, faculty member, etc.).

In using factor analysis as a variable reduction technique, the correlation between two or more variables may be summarized by combining two variables into a single factor. For example, two variables may be plotted in a scatterplot. A regression line may be fitted (e.g., by computer system 102 of FIG. 1) that represents a summary of the linear relationships between the two variables. For example, if there are two variables, a two-dimensional plot may be performed, where the two variables define a plane. With three variables, a three-dimensional scatterplot may be determined, and a plane could be fitted through the data. With more than three variables it becomes difficult to illustrate the points in a scatterplot, but the analysis may be performed by computer system 102 to determine the regression summary of the relationships between the three or more variables. A variable may be defined that approximates the regression line in such a plot to capture the principal components of the two or more items. Data scores from student data on the new factor (i.e., represented by the regression line) may be used in future data analyses to represent that essence of the two or more items. Accordingly, two or more variables may be reduced to one factor, wherein the factor is a linear combination of the two or more variables.

The extraction of principal components may be found by determining a variance maximizing rotation of the original variable space. For example, in a scatterplot, the regression line may be the original X-axis, rotated so that it approximates the regression line. This type of rotation is called variance maximizing because the criterion for (i.e., goal of) the rotation is to maximize the variance (i.e., variability) of the “new” variable (factor), while minimizing the variance around the new variable. Although it is difficult to perform a scatterplot with three or more variables, the logic of rotating the axes so as to maximize the variance of the new factor remains the same.

After a line has been determined on which the variance is maximal, some variability remains around this first line. Upon extraction of the first factor (i.e., after the first line has been drawn through the data), another line may be defined that maximizes the remaining variability. In this manner, consecutive factors may be extracted. Because each consecutive factor is defined to maximize the variability that is not captured by the preceding factor, consecutive factors are independent of each other. Thus, consecutive factors are uncorrelated or orthogonal to each other.

In applying principal component analysis as a data reduction method (i.e., a method for reducing the number of variables), the number of factors desired to be extracted may be selected. As consecutive factors are extracted, the factors may account for decreasing variability. One method to determine when to stop extracting factors may depend on when the “random” variability has significantly decreased (i.e., very little random variability left). A correlation matrix may be used to determine the variance amongst each of the variables. The total variance in that matrix may be equal to the number of variables.

In contrast to the variable reduction methods of principal component analysis described above, principal factor analysis may also be performed by computer system 102 of FIG. 1 to determine the structure in the relationships between variables. The student interaction data may be used to form a “model” for principal factor analysis. For example, the student interaction data may be dependent on at least two components. First, there may be one or more underlying common factors. Each item may measure some part of this common aspect. Second, each item may also capture a unique aspect (of the common aspect) that may not be addressed by any other item.

If this model is correct, the factors may not extract substantially all variance from the items. Rather, only that proportion that is due to the common factors and shared by several items may be extracted. The proportion of variance of a particular item that is due to common factors (shared with other items) is called communality. The communalities for each variable may be estimated (i.e., the proportion of variance that each item has in common with other items). The proportion of variance that is unique to each item may then the respective item's total variance minus the communality. A common starting point is to use the squared multiple correlation of an item with all other items as an estimate of the communality. Alternatively, various iterative post-solution improvements may be made to the initial multiple regression communality estimate.

A characteristic that distinguishes between the two factor analytic models described above is that in principal components analysis (i.e., factor reduction) may assume that substantially all variability in an item should be used in the analysis, while principal factors analysis (i.e., structure detection) may use the variability in an item that it has in common with the other items. In most cases, these two methods usually yield very similar results. However, principal components analysis is often preferred as a method for data reduction, while principal factors analysis is often preferred when the goal of the analysis is to detect structure.

Computer system 102 of FIG. 1 configured with factor analysis applications programming (e.g., as part of applications 108) may identify absences of student interaction data elements based on a student class schedule, dining services plan, course requirements (e.g., assignments, quizzes, tests, labs, etc.). System 102 may use quantitative techniques, such as data gathering from registration system 120 (e.g., swipes of student identification card 122, proximity readings of card 122, registration of digital device 124 configured with personal information, capturing personal identification information entered from computer 126, capturing data from post-graduation self-reporting interface 128, capturing data from post-graduation student survey database 130, etc.) to collect data about a student concerning their attendance at various facilities (e.g., classrooms, dormitories, athletic facilities, dining service facilities, etc.) or other interactions (e.g., meals selections at a dining service facility or off-campus eatery, submission of assignments on-line, etc.). The captured data (taken alone or in combination with other personal data that may be stored, e.g., with campus academic system 116) may be used as input for a statistical application (e.g., applications 108) of computer system 102 of FIG. 1, which may process the data using factor analysis. System 102 may yield a set of underlying attributes (i.e., factors). Upon determination of the factors, system 102 may construct perceptual maps, graphs, or other textual or visual output to indicate early warning of student absence, student health and nutrition problems, or student academic warnings, or any other suitable warning notifications. System 102 may present such maps, graphs, text, and/or warnings in displays for presentation to, for example, an administrator or other designated authority using computer 130 or government agency authority system 132.

Computer system 102 may be configured with programming that is executed to perform factor analysis on one or more elements of data to isolate underlying factors that summarize the resultant information as it relates to providing warning notifications as to student absence, student health and nutrition problems, student academic performance problems, or any other suitable warnings. The factor analysis may be an interdependence technique, wherein one or more sets of interdependent relationships may be examined. The factor analysis may reduce the rating data on different attributes to a few important dimensions (e.g., number of missed meals at a dining services facility, what foods were eaten at a dining services facility, which course assignments were missed, number of classes missed, etc.). This reduction is possible because the attributes are related (e.g., the absence of classroom attendance data relates to academic performance, absence of data relating to utilization of dining services or off-campus eateries relates to health and nutrition problems, etc.). The rating given to any one attribute is partially the result of the influence of other attributes. Thus, system 102 may determine which facilities and campaigns utilized by a person (e.g., student, faculty member, staff member, administrator, community member, etc.). System 102 may also provide recommendations as to resource allocation based at least in part on the determined utilization data. The statistical programming (e.g., application 108) implemented on system 102 may deconstruct the rating (i.e., raw score) into one or more components, and reconstruct the partial scores into underlying factor scores. The amount of correlation between the initial raw score and the final factor score is referred to as factor loading.

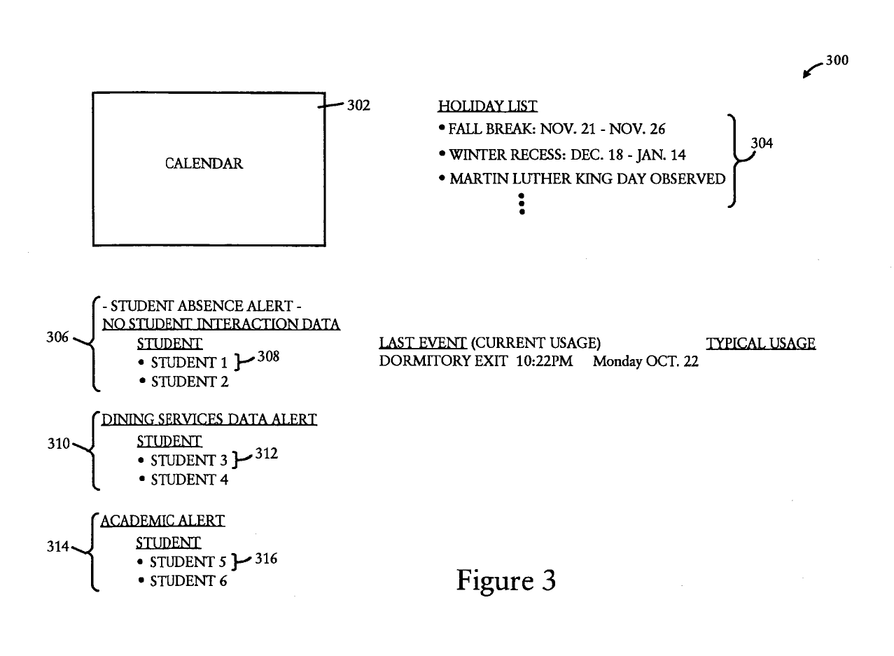

Display 300 of FIG. 3 illustrates an exemplary interface for a designated user or administrator using computer 130 (FIG. 1) to view notifications received by educational authority system 128 from system 102. Display 300 may have academic calendar 302, which may be a monthly calendar, semester calendar, quarter calendar, trimester calendar, academic year calendar, or any other suitable calendar. Educational institution holiday list 304 may indicate one or more days in which the educational institution is closed or is not holding classes (e.g., for national holidays, local holidays, religious observances, etc.). Holiday list 304 may reflect the observed holidays for the period (e.g., month, semester, quarter, trimester, etc.) displayed in academic calendar 302.

Notification area 306 may indicate one or more students who have not engaged with the educational institution (e.g., attended class, used a dormitory, used dining services, attended a cultural event, etc.) for a predefined period of time (e.g., 4 hours, 8 hours, 1 day, 2 days, 3 days, 1 week, etc.). As described above, student activity and engagement with the educational institution may be monitored by capturing student interaction data (e.g., data from student identification card 122, student digital device 124, or student computer 126, etc.) with event registration system 120 as shown in FIG. 1. Notification area 306 may also indicate the time, date, and other information of the captured student interaction data by event registration system 120. For example, a student may have last used student identification card 122 to exit a dormitory at 10:22 PM on Monday, October 22 and no additional data has been captured by event registration system 120 after this date and time.

An administrator or other individual using computer 130 may select student data 308, and educational institution authority system 128 may present display 400 depicted in FIG. 4. Display 400 may indicate student interaction data list 402 for a particular time period (e.g., one day, three days, one week, two weeks, etc.) captured by event registration system 120. Student interaction data 404 may indicate data captured by event registration system 120 for a particular day. Student interaction data 404 may, for example, indicate the times for entry and exit from Calculus I class, Physics I class, American Literature class, the dining services facility, the educational institution's computer network, the library, and the dormitory. As displayed in student interaction data 404, the last student data captured by event registration system 120 was the student exiting the dormitory at 10:22 PM on October 22. As further illustrated in display 402, no student interaction data has been captured for the dates October 23 through October 26. For example, applications 108 of computer system 102 may provide a notification to educational institution authority system 128 when there is an absence of student data for two days. As no data was captured for the student for October 23 and October 24, system 102 may provide a notification to authority system 128.

Student information 406 of display 400 may indicate the name of the student, residence of the student (e.g., dormitory name, off-campus housing address, etc.), contact information (e.g., email address, phone number), whether the student is a visiting student with a student visa, parent or guardian contact information, or any other suitable information, or any combination thereof.

Upon review of the student interaction data list 402, an administrator or other individual may make selections to forward notifications to other portions of the educational institution or to government agencies. An administrator may select one or more entities from entities list 408 which may include, for example, campus security, local police, FBI, State Department, Department of Homeland Security, parents or guardian, or any other suitable contact to provide notification of student absence. Upon selection of one or more entities from entities list 408, a user may select submit button 410. Educational institution authority system 128 may then communicate notifications to the selected entities. Authority system 128 may provide each of the selected entities with an email notification, voice notification via a telephone system (e.g., selected entity may received an automated voice message or may receive a telephone call from an administrator or other person regarding the student absence), a letter sent via a postal entity or via facsimile, or any other suitable communication.

The contact information for each selected entity may be stored, for example, in a database or other such system in authority system 128, data storage 112, or any other suitable system. For example, if the student indicated in display 400 is a foreign student, the administrator may select that notification to the State Department (i.e., the entity that issued the student visa) may be notified, along with the Department of Homeland Security. These notifications may be sent to government agency authority system 132. Although only one system 132 is illustrated in FIG. 1, there may be computer systems for each agency selected to receive a notification.

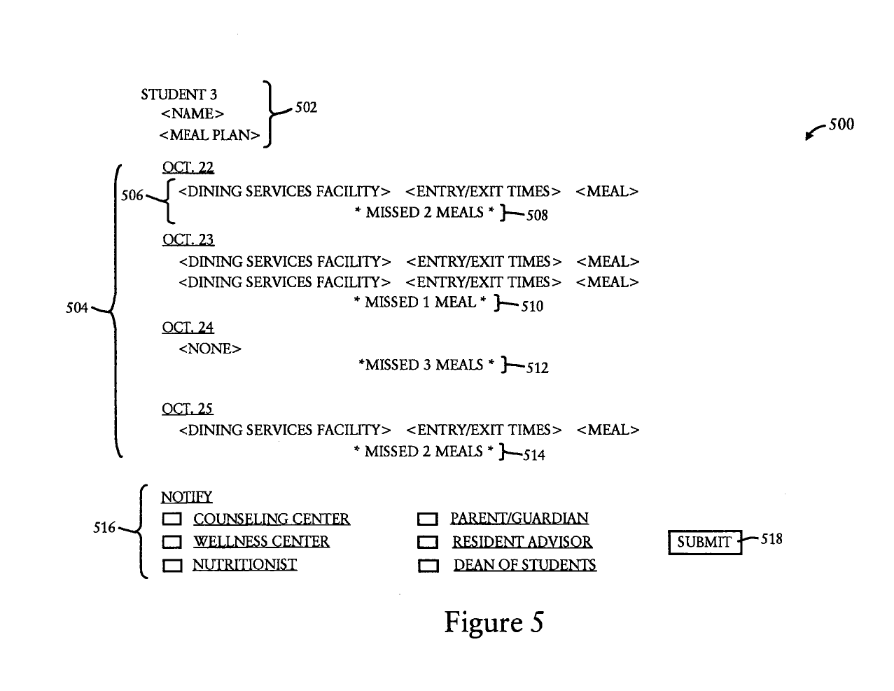

Turning again to display 300 of FIG. 3, notification area 310 may indicate dining services data alerts for students who have elected to have student dining plans and have not utilized the dining services of the educational institution. For example, notification area 310 may indicate the number of meals missed by a student in a predefined period of time. A administrator or other user may select student data 312, and authority system 128 may present display 500 of FIG. 5. Student information 502 may indicate the name of the student, as well as the type of meal plan that the student has (e.g., 21 meals per week plan, 14 meals per week plan, declining balance account meal plan, etc.). Dining service data list 504 may indicate dining services data collected from a student, and may display the dining services data for a particular range of time (e.g., three days, one week, two weeks, one month, etc.). student dining data 506 may indicate the times of entry and exit to a dining service facility, data related to the meal selected (e.g., grilled chicken with rice and broccoli, and a 12 fluid ounce water, etc.), and may also indicate how may meals (if any) were missed, based on the student's meal plan. For example, warning 508 may indicate that the student missed two meals on October 22. Warning 510 may indicate that a student missed one meal on October 23, warning 512 may indicate that a student missed three meals on October 24, and warning 514 may indicate that a student missed two meals on October 25.

Factor analysis, as described above, may be used by applications 108 of system 102 to determine nutrition problems or eating disorders. Based on the student's meal plan selection, a predetermine number of meals may be missed before a notification is send by applications 108 of computer system 102 to the authority system 128. An administrator or other user viewing display 500 may review the dining services data list and may select entities from entities list 516 to send additional notifications regarding the student's eating habits. Entities list 516 may include, but is not limited to the educational institution's counseling center, wellness center, nutritionist, parent or guardian, resident advisor, mentor, or any other suitable person or entity. An administrator or other user may select one or more of the entities from entity list 516, and the select submit button 518 in order to provide notifications regarding the student's eating habits to the designated entities. Notification to the selected entities may be via email, a telephonic message (e.g., an automated voice message or a telephone call from an administrator or other designated person), a letter sent via the postal mail, or any other suitable communication.

Turning again to FIG. 3, display 300 may indicate academic alert area 314, which may identify one or more students identified by applications 108 of computer system 102 as meeting predetermined criteria for receiving an academic alert. Such criteria may include, but is not limited to missed classes, assignments, tests or quizzes, laboratories, or any other academic event. An administrator or other user may select a student (e.g., student 316) to view additional student absence information.

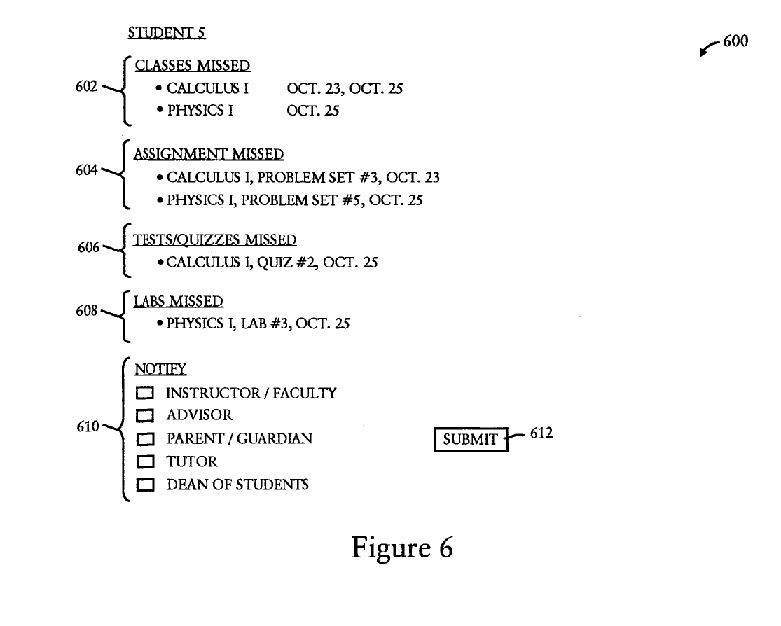

Upon selection of student 316, educational institution authority system 128 may present display 600 of FIG. 6 to an administrator or other person utilizing computer 130. Display 600 may indicate classes missed 602, which may include one or more class titles and the one or more dates that a particular class was not attended to by a student (e.g., Calculus I class was missed on October 23 and October 25, and Physics I class was missed on October 25, etc.). Display 600 may also indicate assignments missed 604, tests or quizzes missed 606, or laboratories missed 608, or any other suitable information.

An administrator or other designated individual may select one or more entities from entities list 610, which may include, but is not limited to instructor or faculty member, academic advisor, parent or guardian campus tutor, or any other suitable individual or entity. Upon selection of one or more entities from entities list 610, a user may select submit button 612 to notify the selected entities of the student's academic warning. Notifications may be provided, for example, by email, by a telephonic message (e.g., an automated message or a telephone call from an administrator or other designated person), by letter via a postal carrier or facsimile, or by any other suitable communication.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for electronically providing notification that a student has not been engaged with an educational institution for a predefined period of time, comprising:
capturing student interaction data, wherein the student interaction data has one or more data elements and relates to use of the one or more facilities, services, or facilities and services of the educational institution;
determining an absence of student interaction data for the predefined period of time; and
providing a notification to a predefined authority based on the determined absence of student interaction.

2. The method of claim 1, wherein the capturing student interaction data comprises reading a swiped card configured with student data, reading a card configured with personal data with a proximity reader, retrieving student data stored on an electronic device via a wired or wireless communication interchange, recording a computer login event using student identifier data, or digitally capturing student identification information from an electronically submitted communication, or any combination thereof.

3. The method of claim 2, wherein the captured student interaction data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, on-campus retail facilities utilization, off-campus retail facilities utilization, on-line retail facilities utilization, entertainment facilities utilization, library facilities utilization, or student center facilities utilization, on-campus resource utilization, off-campus resource utilization, or any combination thereof.

4. The method of claim 3, further comprising correlating of the captured student interaction data indicating the dining facilities utilization data with student wellness, and wherein the providing the notification to a predefined authority is based on the absence of dining facilities student interaction data.

5. The method of claim 1, further comprising comparing an academic calendar of the educational institution with the determined absence of student interaction data.

6. The method of claim 1, wherein the determining the absence of student interaction data further comprises determining if the student is a visiting student.

7. The method of claim 1, further comprising:
monitoring student academic performance; and
correlating the absence of student interaction data with student academic performance.

8. The method of claim 7, wherein the determining the absence of student interaction data for the predefined period of time further comprises applying factor analysis.

9. A system for electronically providing notification that a student has not been engaged with an educational institution for a predefined period of time, comprising:
a programmable computer configured to:
capture student interaction data, wherein the student interaction data has one or more data elements and relates to use of the one or more facilities, services, or facilities and services of the educational institution;
determine an absence of student interaction data for the predefined period of time; and
provide a notification to a predefined authority based on the determined absence of student interaction.

10. The system of claim 9, wherein the programmable computer is further configured to receive reading a swiped card configured with student data, read a card configured with personal data with a proximity reader, retrieve student data stored on an electronic device via a wired or wireless communication interchange, record a computer login event using student identifier data, or digitally capture student identification information from an electronically submitted communication, or any combination thereof.

11. The system of claim 10, wherein the captured student interaction data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, on-campus retail facilities utilization, off-campus retail facilities utilization, on-line retail facilities utilization, entertainment facilities utilization, library facilities utilization, or student center facilities utilization, on-campus resource utilization, off-campus resource utilization, or any combination thereof.

12. The system of claim 11, wherein the programmable computer is further configured to capture student interaction data indicating the dining facilities utilization data with student wellness, and wherein the programmable computer configured to provide the notification to a predefined authority is based on the absence of dining facilities student interaction data.

13. The system of claim 9, wherein the programmable computer is further configured to compare an academic calendar of the educational institution with the determined absence of student interaction data.

14. The system of claim 9, wherein the programmable computer is further configured to determine determining if the student is a visiting student.

15. The system of claim 9, wherein the programmable computer is further configured to:
monitor student academic performance; and
correlate the absence of student interaction data with student academic performance.

16. The system of claim 15, wherein the programmable computer is further configured to determine the absence of student interaction data for the predefined period of time by applying factor analysis.

17. Computer readable media containing programming instructions for providing notification that a student has not been engaged with an educational institution for a predefined period of time, that upon execution thereof, causes one or more processors to perform the steps of:
capturing student interaction data, wherein the student interaction data has one or more data elements and relates to use of the one or more facilities, services, or facilities and services of the educational institution;
determining an absence of student interaction data for the predefined period of time; and
providing a notification to a predefined authority based on the determined absence of student interaction.

18. The method of claim 17, wherein the capturing student interaction data comprises reading a swiped card configured with personal data, reading a card configured with personal data with a proximity reader, retrieving student data stored on an electronic device via a wired or wireless communication interchange, recording a computer login event using student identifier data, or digitally capturing student identification information from an electronically submitted communication, or any combination thereof.

19. The computer readable media of claim 18, wherein the captured student interaction data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, on-campus retail facilities utilization, off-campus retail facilities utilization, on-line retail facilities utilization, entertainment facilities utilization, library facilities utilization, or student center facilities utilization, on-campus resource utilization, off-campus resource utilization, or any combination thereof.

20. The computer readable media of claim 19, further comprising correlating of the captured student interaction data indicating the dining facilities utilization data with student wellness, and wherein the providing the notification to a predefined authority is based on the absence of dining facilities student interaction data.

21. The computer readable media of claim 17, further comprising comparing an academic calendar of the educational institution with the determined absence of student interaction data.

22. The computer readable media of claim 17, wherein the determining the absence of student interaction data further comprises determining if the student is a visiting student.

23. The computer readable media of claim 17, further comprising:
monitoring student academic performance; and
correlating the absence of student interaction data with student academic performance.

24. The computer readable media of claim 23, wherein the determining the absence of student interaction data for the predefined period of time further comprises applying factor analysis.

25. A method for electronically determining absence of student interactions with an educational institution, comprising:
capturing student interaction data, wherein the student interaction data has one or more data elements;
correlating the student interaction data elements with a student's class schedule and the educational institution's academic calendar;
determining the absence of student interaction data based on the captured student interaction data and correlated data; and
providing a notification to an authority regarding the student absence when the absence data exceeds a predefined absence data threshold.
